(19) United States
(12) Patent Application Publication
(10) Pub. No.: US 2008/0270529 A1
(43) Pub. Date: Oct. 30, 2008

(54) Method for the Transmission of Content Visualization Data Between a Server and at Least One Client Terminal, Corresponding Terminal and Computer Program

(75) Inventors: Romain Cavagna, Chasne sur Illet (FR); Jerome Royan, Chasne sur Illet (FR); Olivier Aubault, Rennes (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: France Telecom, Rennes (FR)

(21) Appl. No.: 11/908,381

(22) PCT Filed: Feb. 27, 2006
(86) PCT No.: PCT/EP2006/060312

§ 371 Date: May 27, 2008

(30) Foreign Application Priority Data
Mar. 11, 2005 (FR) 05/02449

(51) Int. Cl. G06T 17/00; G06F 15/16

(52) U.S. Cl. 709/203

(57) ABSTRACT

A method and apparatus are provided for transmitting content display data between a server and at least one client terminal, whereby said data are arranged into nodes of a hierarchical tree including at least one parent node and at least one son node, a displayable element being associated with each node. One such method includes the following steps in which: the server transmits a simplified representation of the tree to the client, said representation including, for at least some of the nodes, only information for locating the displayable element in the content to be displayed; the client terminal selects at least one node of interest from the simplified representation as a function of a criterion relating to the distance from the client to the displayable element that is associated with the node of interest in the content to be displayed; and geographical data are transmitted in order to enable said displayable element to be reconstructed for the selected nodes(s) of interest.

### CROSS-REFERENCE TO RELATED APPLICATION

This Application is a Section 371 National Stage Application of International Application No. PCT/EP2006/060312, filed Feb. 27, 2006 and published as WO 2006/094919A1 on Sep. 14, 2006, not in English.

### FIELD OF THE DISCLOSURE

The field of the disclosure is that of the visualization of 2D and 3D images and 3D scenes. More specifically, the disclosure relates to a technique of data transmission used to visualize such images and such scenes on a client terminal.

The disclosure can be applied more particularly to the field of the consultation of multilevel detailed information in which the data is structured in a tree-like form and in which each node of the tree corresponds to a precise element to be viewed at a given level of detail. It is especially valuable in the network visualization of huge environments such as models of towns for example but can be applied more generally to any type of data organized in a hierarchical tree, whether it is 3D contents or progressive images for example.

### BACKGROUND

1. Prior Art Solutions

There is a growing need to be able to achieve the fast and interactive visualization, on a client terminal, of large-sized scenes or images stored in a server which the client accesses through a communications network such as the Internet. Now, the databases needed to reconstruct such 3D models or such progressive images are increasingly bulky (especially when, for example, they enable progressive and hierarchical representation of big towns) and the cost of their transmission to the client terminal (in terms of bandwidth or transmission time) is therefore increasingly high.

To date, two main techniques are known for the transmission of visualization data in a client-server type architecture presented here below with reference to FIGS. 1 and 2.

In the first of these techniques, the server 10 transmits the totality of the visualization data to the client 11 before this client 11 can start rebuilding the associated representation, or if necessary navigate therein. It can be applied especially to the transmission of VRML (Virtual Reality Modelling Language) encoded 3D scenes, for which gradual or progressive transmission of the data is not possible.

Thus, the client 11 sends a first request 12₁ to the server 10 asking it to transmit all the data present in the base, and enabling the reconstruction of a representation of a 3-D image of scene. The server 10 responds in a step 13₁ by transmitting the totality of the required model. The client 11 can then navigate 14₁ in the loaded model. If the client 11 wishes to change 15 of model, he must send a new request 12₂ for a model to which the server 10 responds by a new transmission 13₂ of the totality of the visualization data associated with the new model requested. It is only after this new model has been totally loaded that the client 11 can start navigating 14₂ in its representation.

The second prior-art transmission technique, illustrated in FIG. 2, relies on the progressive transmission of the (2D or 3D) model of the server 10 to the client 11. It relates to the images, or 3D contents, encoded in a tree-like structure or hierarchical structure whose visualization, at a given instant, requires that all the parent nodes of the active nodes (i.e. the nodes rendered in the visual representation of the model at the instant considered) should be available. Indeed, in the case of a hierarchical structure, there is high dependency between the nodes of the structure, since the client cannot know of the existence of an element if the parent element has not yet been transmitted. In such a context of data transmission on demand, the client must therefore ask for the son nodes and then await their transmission before being able to ask for the following son nodes.

Thus, according to this technique, to be able to consult a piece of data at the level of detail adapted to the user's viewpoint, it is necessary to carry out a progressive transmission of the hierarchical tree. The refining of the tree is done recursively, starting from the parent node to the nodes corresponding to the current point of view. The scanning of the tree is therefore done in depth.

The first step 21 enables the client 11 to retrieve 21₂ the first node 24 of the tree which it receives after having sent a specific request 21₁ to the server 10. The steps 22 and 23 that follow enable the client 11 to retrieve the information that he needs as a function of its position in the scene or in the image. After having retrieved 21₂ the first node 24 it can, depending on its position, determine whether or not it needs to develop it, i.e., whether its position calls for a more detailed representation of the scene or of the image. It performs this operation recursively until it converges on the optimal model corresponding to its position.

Thus, after each reception of one or more nodes of the tree, the client 11 scans or goes through 25 the tree after having reconstructed it to determine whether it needs son nodes of certain of the nodes which it already has available to it: in other words, it determines whether one or more nodes of the tree have to be developed. In FIG. 2, the client 11, during the scanning 25₁ of the tree, thus determines that the first node 24 must be developed. During the step referenced 22, it addresses a request 22₁ to the server 10 which in return sends it 22₂ the requested son nodes 26 and 27. A new scan 25₂ of the tree enables it to determine that it needs son nodes of the nodes 26 and 27 which it has just received. It therefore sends a new request 22₃ to the server 10 which in return sends it 22₄ the son nodes of the nodes 26 and 27. In the event of a change in position 15 of the custom 11, a new scan of the tree 25₃ enables it to determine that the node 26 is no longer necessary for it but that the son nodes of the node 27 might need to be developed. It then sends a corresponding request 23₁ on these lines to the server 10.

2. Drawbacks of Prior Art

One drawback of the first transmission technique of FIG. 1 is that it is not suited to the transmission of models or complex images associated with a major volume of visualization data. Indeed, for such models, the time for the initial transmission of data from the server to the client is very great and even prohibitive for the client who has to wait for the complete loading of the model before he can start viewing it. In this first technique, the user therefore cannot navigate quickly in the image or in the scene.

The second transmission technique of FIG. 2 can be used to resolve this problem of waiting for the complete loading before the viewing can begin. However, its drawback is that it generates a major exchange of messages (requests 21₁, 21₂, 22₁ to 22₄, 23₁, . . . ), especially when the desired level of detail corresponds to a deeper branch of the tree structure.

Another drawback of this technique is that it induces the transmission of unnecessary information, especially from certain nodes which are not viewed by the client. Indeed, upon reception of a request for development of a node, the server sends the client all the son nodes of the node to be developed.

Furthermore, many custom-server exchanges in the prior art as shown in FIG. 2 limit the speed at which the tree structure with the client converges toward the optimum level of detail depending on the user's position. One drawback of this technique therefore is that the progressive refining of the representation of the image or the scene is visible to the client at the start of the navigation, causing visual discomfort for this client.

These drawbacks also appear when the client moves speedily in the scene or in the image: the lack of information matching the user's new viewpoint induces visibility of the successive refining operations as and when new nodes are received from the server. Again, the tree-scanning mode and the exchanges that it provokes do not provide for fast convergence toward the optimum level of detail.

### SUMMARY

An embodiment of the invention proposes an approach that does not have these drawbacks of the prior art and takes the form of a method for the transmission of data for the visualization of content between a server and at least one client terminal, said data being arranged in nodes of a hierarchical tree comprising at least one parent node and at least one son node, a visualizable element being associated with each of said nodes.

According to an embodiment of the invention, a method of this kind comprises the following steps:
transmission by said server to said client of a simplified representation of the tree comprising, for at least certain of said nodes, only one piece of information for locating said visualizable element in said content to be visualized;
selection, by said client terminal, from said simplified representation, of at least one node of interest, as a function of a criterion of distance of said client from said visualizable element associated with said node of interest, in said content to be visualized;
transmission of geometrical data enabling a reconstruction of said visualizable element for said selected node or nodes of interest.

Thus, an embodiment of the invention relies on a wholly novel and inventive approach to the transmission, between a server and one or more client terminals, of visaulization data arranged in a tree structure. Indeed, an embodiment of the invention relies on the initial transmission of a simplified tree structure that does not contain the geometrical data enabling the reconstruction of the image or the scene but enables the user to view the full hierarchical tree and select the node or nodes containing geometrical data necessary for the reconstruction of the scene or image, as a function of its current viewpoint. He can then generate requests corresponding precisely to his needs.

This technique of transmission can be used, as compared with prior-art techniques, for faster loading of tree-structured data, and therefore enables the user to start a scene visualization or image visualization with an optimum level of detail, adapted to his viewpoint. An embodiment of invention provides the same advantage in the case of a rapid change in the user's position.

Thus, in one advantageous embodiment, the invention proposes faster convergence to an optimum level of detail of the representation, both during initialization and in the event of a fast change in the user's position. Thus, in this advantageous embodiment, the invention proposes a technique enabling a visual rendering that is pleasing to the user without the successive refinements of the reconstructed image or scene being visible.

According to one particular embodiment, the invention is adapted to a networked use of tree-structured type contents and enables the optimizing of the visualization applications which work in request mode. Thus, in this particular embodiment, the invention proposes a technique of transmission of visualization data arranged in a tree-like structure that is well suited to a custom-server architecture working in request mode.

Advantageously, an embodiment of the invention is adapted to client terminals having various processing capacities, especially, a custom-server architecture in which a large number of client terminals access a same data server.

Furthermore, in certain embodiments of the invention, a visualization data transmission technique of this kind costs little in resources, especially in terms of bandwidth and transmission time.

Preferably, said simplified representation comprises the following for each of said nodes of the tree:
an identifier of said node;
a piece of information enabling said node to be linked to said parent node of said node and/or to said son nodes of said node;
a position of a centre of said visualizable element associated with said node in said content to be visualized (for example the centre of gravity of the element in a Cartesian reference system associated with the scene or with the image)
a zone of selection of said visualizable element associated with said node.

A selection zone of this kind is, for example, a sphere with a radius R if the content to be visualized is a 3D scene, or a disk with a radius R if the content to be visualized is a 2D image. It can also take any other form adapted to the nature of the content or to the needs of the application in view.

The information used to link up a son node with a parent node, for its part, may take the form of an identifier of the parent node of the node considered in the simplified tree. It is also possible, for a given node, to choose to indicate its number of sons in the simplified representation and then transmit the content of these son nodes if necessary.

Advantageously, a node of said tree is selected as a node of interest if a current position of said client is included in said selection zone. For example, the user's position in a Cartesian reference system associated with the scene or with the image is looked at and it is determined whether this position is contained in the sphere with a radius R associated with the node considered.

According to one advantageous characteristic, said client terminal sends said server a request for obtaining said visualization data of said nodes of interest. Using the geometrical data contained in the nodes of interest, the client can indeed reconstruct a representation of the image or of the scene adapted to his viewpoint. These requests are targeted and correspond perfectly well to the user's requirements, thus preventing any transmission of unnecessary data.

A user can also navigate swiftly in the reconstructed scene or image.

Preferably, as a preliminary to said sending operation, said client terminal verifies the presence of said data of said nodes of interest in a cache of said terminal and said request is not sent to said server was said data already present in said cache.

The server thus transmits only the geometrical data necessary for the user but not yet available to him: any unnecessary overloading of the network is prevented by limiting the data traffic to what is strictly necessary.

According to another advantageous characteristic of an embodiment of the invention, in the event of a change in said current position of said client, said client terminal asks the server for cancellation of said request for obtaining said data from at least one node which is no longer a node of interest, if said data have not yet been transmitted by said server.

Indeed, a certain period of time may elapse between the instant at which the user requests certain geometrical data from the server and the instant at which the server complies with the user's request. If, in the meantime, the user has moved in the scene or in the image, and if the data requested has become obsolete, he may inform the server of this in order to prevent the server from transmitting information that has become unnecessary.

Advantageously, during said selection step, said client terminal scans a node of said simplified representation to determine whether said criterion of distance is verified for said scanned node only if said parent node of said scanned node is a node of interest. Thus, when the user tests the different nodes of the hierarchical tree to determine whether the geometrical data that they contain are necessary for visualizing the content, he does not scan the son nodes of a father node if this father node is not a node of interest. It is thus not necessary to scan the tree entirely to determine the nodes which are visible. This characteristic flows directly from the property of inclusion of the zones of selection of the father and son nodes which shall be described in greater detail here below.

An embodiment of invention also relates to a computer program product comprising program code instructions for the execution of the steps of the method for the transmission of content visualization data between a server and at least one client terminal described here above, when said program is executed by a processor.

An embodiment of invention also relates to a data server for the visualization of a content designed for at least one client terminal, said data being arranged in nodes of a hierarchical tree comprising at least one parent node and at least one son node, a visualizable element being associated with each of said nodes. Such a server comprises:
means of generation and transmission to said client of a simplified representation of said tree comprising, for at least certain of said nodes, only one piece of information for locating said visualizable element in said content to be visualized so that said client performs a selection, from said simplified representation, of at least one node of interest, as a function of a criterion of distance of said client from said visualizable element associated with said node of interest, in said content to be visualized; and
means of transmission to said client of geometrical data enabling a reconstruction of said visualizable element for said selected node or nodes of interest.

An embodiment of invention also relates to a computer program product comprising program code instructions recorded on a carrier usable in or by a computer, said program enabling the transmission of data for the visualization of a content between a server and at least one client terminal, said data being arranged in nodes of a hierarchical tree comprising at least one parent node and at least one son node, a visualizable element being associated with each of said nodes. Such a computer program comprises:
computer-readable programming means to carry out a step of transmission by said server to said client of a simplified representation of said tree comprising, for at least certain of said nodes, only one piece of information for locating said visualizable element in said content to be visualized;
computer-readable programmable means for the performing of a step of selection by said client terminal, from said simplified representation, of at least one node of interest, as a function of a criterion of distance of said client from said visualizable element associated with said node of interest, in said content to be visualized; and
computer-readable programming means to perform a step of transmission to said client of geometrical data enabling a reconstruction of said visualizable element for said selected node or nodes of interest.

An embodiment of invention also relates to a client terminal for the visualization of a content data from visualization data arranged in nodes of a hierarchical tree comprising at least one parent node and at least one son node, a visualizable element being associated with each of said nodes. Such a terminal comprises:
means of reception of a simplified representation of said tree, transmitted by a server, and comprising, for at least certain of said nodes, only one piece of information for locating said visualizable element in said content to be visualized;
means of selection, from said simplified representation, of at least one node of interest, as a function of a criterion of distance of said client from said visualizable element associated with said node of interest, in said content to be visualized; and
means of transmission to said client of geometrical data enabling a reconstruction of said visualizable element for said selected node or nodes of interest.

### BRIEF DESCRIPTION OF THE DRAWINGS

Other features and characteristics will appear more clearly from the following description of a particular embodiment, given by way of a simple illustrative and non-restrictive example, and from the appended drawings, of which:

FIG. 1, already described with reference to the prior art, presents a technique for the transmission of visualization data between a server and a client terminal, relying on total, prior transmission of the model to be visualized;

FIG. 2 also illustrates a prior art technique implementing a progressive transmission of the model to be visualized, by successive exchanges of requests between the client and the server;

FIG. 3 presents a block diagram of the transmission technique of an embodiment of the invention;

FIG. 4 describes a PBTree type tree structure associated with a 3D representation of a town, in a particular example of an embodiment of the invention;

FIG. 5 is a block diagram of the method of generation of the tree structure of FIG. 4;

FIG. 6 illustrates the geometrical representation of the description file of the tree structure generated according to the diagram of FIG. 5;

FIG. 7 is a block diagram of the mechanism of selection of the nodes of interest by the client terminal;

FIG. 8 illustrates an example of a 2D image in which the selection zones are not regular;

FIGS. 9 and 10 present block diagrams of a server and a client terminal according to an embodiment of the invention.

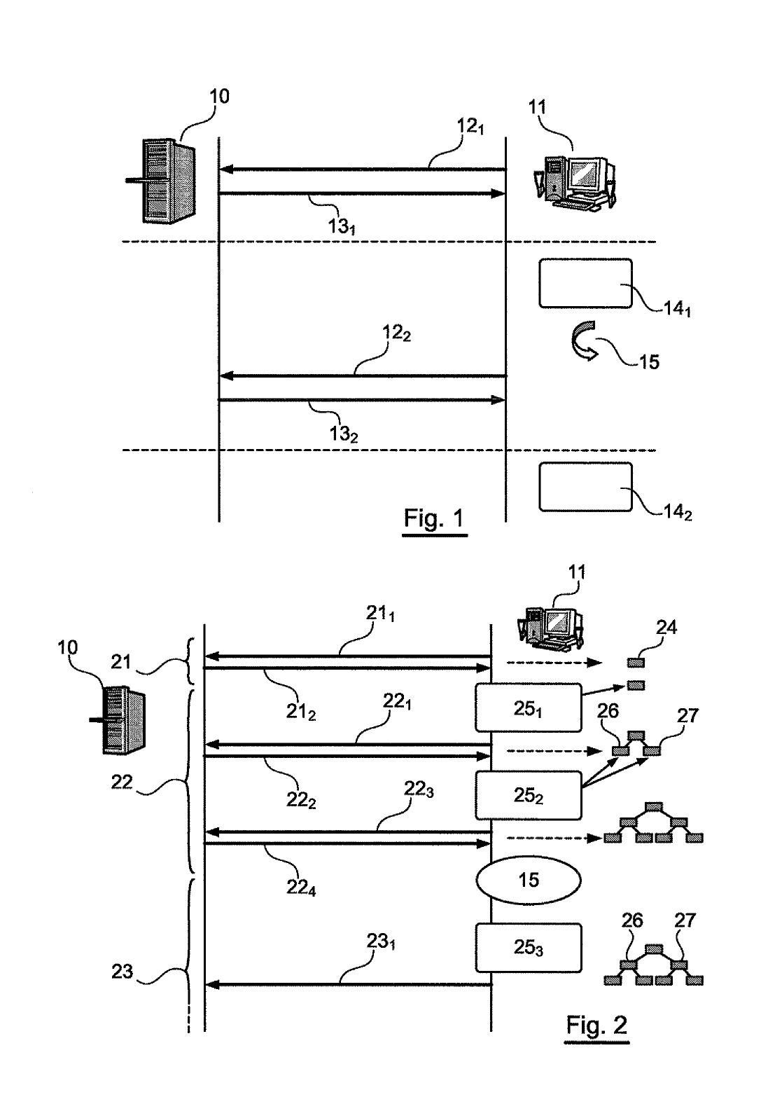

### DETAILED DESCRIPTION OF ILLUSTRATIVE EMBODIMENTS

1. General Presentation

A general principle of the disclosure relies on the transmission by a server to a client of a simplified representation of the tree structure of data enabling the visualization of 3D images or scenes (and not of the geometrical data contained in this structure), and on the selection by the client, from this simplified representation, of the geometrical data that he needs according to his viewpoint.

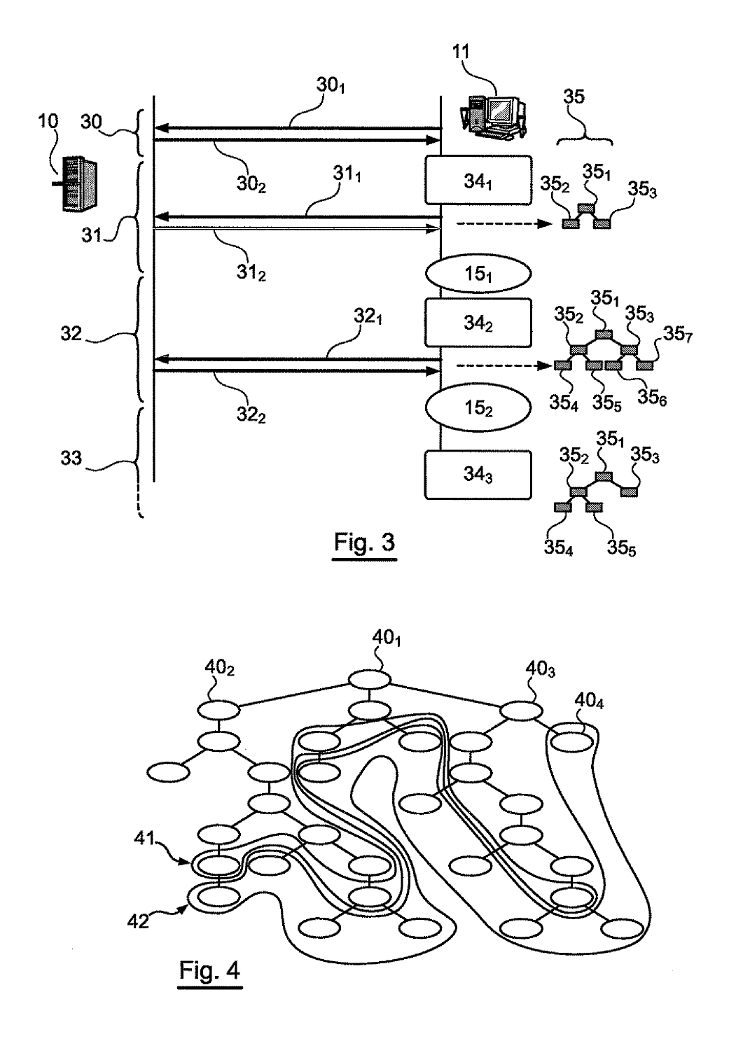

Referring to FIG. 3, an embodiment is presented of the client-server exchanges according to an example. This example of an embodiment dictates the inclusion of the selection zones of the sons in the selection zones of the fathers.

The first phase 30 corresponds to the initialization of the client 11. After a connection procedure 30₁, he receives 30₂ a file with a simplified description of the scene or image to be viewed. This tree description file is generated by the server 10 and contains only the information used for the selection of the nodes to be visualized. Thus, for each node associated with a level of detail of the tree, the file contains its position in the reference system of the scene as well as a selection zone, i.e. for each of the nodes:
the index of the node;
the position of the centre of the node (position x, y, z of the centre of gravity, for example in a Cartesian reference system associated with the image or the scene);
the selection zone for this node (a radius r for example if the selection zone is a sphere or a disk);
the index of the father node.

When the client receives 30₂ the tree description file, the terminal 11 decodes this file and then verifies that the selection zones for the set of sons of the nodes are included in the selection zone of the fathers. If need be, the client makes the corrections required for compliance with this property of inclusion, in widening the selection zones for the father nodes. Once the corrections have been made, the client reconstructs the tree structure that has been transmitted. It will be noted that this verification is not imperative, and could be done by the server or by a third-party device.

The second phase (31 to 33) corresponds to the visualization of the scene. During this visualization phase, the client 11 takes charge of the selection of the nodes 35 to be visualized as a function of the user's position in the scene or the image (expressed also in the form of (x, y, z) coordinates in a Cartesian reference system associated with the scene or image). He uses (34₁ to 34₃) the description file transmitted to him by the server 10 at initialization 30. If the current position of the user 11 is included in the selection zone of a node 35ᵢ, this node is selected. At each instant, depending on the data loaded and the nodes required, the client sends requests to the server so as to receive the visualization data. The information that the client 11 needs for the visualization of the scene or image may be geometrical representations, compressed images, links to textures, wavelet coefficients etc.

Thus, in a first visualization step 31, the client 11 scans 34₁ the simplified representation of the tree received 30₂ from the server 10, and determines that it needs the geometrical data contained in the nodes referenced 35₁ to 35₃. He sends the server 10 a request 31₁ for obtaining this data and the server 10 transmits 31₂ this data to him. The client 11 can then view the elements of the scene or of the image associated with the nodes referenced 35₁ to 35₃. For example, if the scene is a model of a town, the client 11 visualizes the buildings that he sees according to his position.

After a first movement 15₁ by the user in the scene, the client terminal again scans 34₂ the simplified tree, tests each of the nodes of the tree and determines that it too has need of the geometrical data contained in the son nodes 35₄ to 35₇ of the previously received nodes 35₂ and 35₃. It then sends the server 10 a request 32₁ for obtaining this missing data, and the server sends 32₂ this data to it. Upon reception, the client rebuilds the representation of all the elements associated with the nodes referenced 35₁ to 35₇, from the received data (35₄ to 35₇), and data already present in its cache (35₁ to 35₃).

In the event of a new change in position 15₂ of the client, the user starts a third visualization step 33 through a new scan 34₃ of the simplified tree by which he can determine that, given his new position, only the nodes referenced 35₁ to 35₅ constitute nodes of interest for him. Since all the geometrical data contained in these nodes of interest 35₁ to 35₅ are already stored in the cache of the client terminal 11, no exchange with the terminal is needed for this third visualization step 33: the client 11 uses the data that he has already loaded.

This transmission technique illustrated in FIG. 3 can be applied to any type of tree-structured data and, especially, to multilevel representations of details of 3D scenes and 2D images. Indeed, a multilevel representation of details enables the complexity of the scene or image to be adapted to the viewpoint. A structuring made in tree form is used to store the different levels of details of the scene. The root node then represents the coarser level of detail and the leaf nodes correspond to the more detailed models of the scene (initial models). Several pieces of information may be stored in the nodes of the tree.

Thus, for example, in the case of 3D scenes, we may cite the following:
The “Vertex Trees” proposed by Hoppe (in “Efficient Implementation of Progressive Meshes”, Computer and Graphics, vol. 22, pp. 27-36, 1998) or Luebke (in “View-Dependent Simplification of Arbitrary Polygonal Environments”, Computer Graphics SIGGRAPH 97, vol. 31, pp. 199-208, New York, 1997, ACM Press) which stores ridge mergers;
The PBTree, proposed by J. Royan et al. (in “PBTree—A new progressive and hierarchical representation for network-based navigation in urban environments”, VMV 2003, Munich, Germany) stores simplifications made on buildings represented as 2D½ data (ground footprint, altitude, height);
The VRML levels of detail enabling the storage of a facet index for each level of detail of a 3D object.
   As for multilevel representations of details of images such as the MPEG4 (“Motion Picture Expert Group”) VTC and JPEG 2000 (“Joint Picture Expert Group”) representations, the tree structure is implicit and relies on a subdivision of the image into nested pixel zones (for example the image is subdivided into four zones, associated with four nodes of the tree, and then each of these parent zones is in turn subdivided into four son zones associated with four son zones of the tree, and so on and so forth). Items of information are transmitted to refine such and such a zone of the image.

Here below in this document, it will be attempted more particularly to describe an example relying on the hierarchical PBTree structure presented here above.

2. Description of a Particular Embodiment

A description is provided here below of an example of a particular embodiment, in which the selection of the data associated with a level of detail relies on a position of the centre of gravity of the visualizable element associated with them in the scene or in the image to be visualized. Here below, the description will focus on the 3D representation of a town, described on the basis of the PBTree multilevel detail algorithm by J. Royan et al.

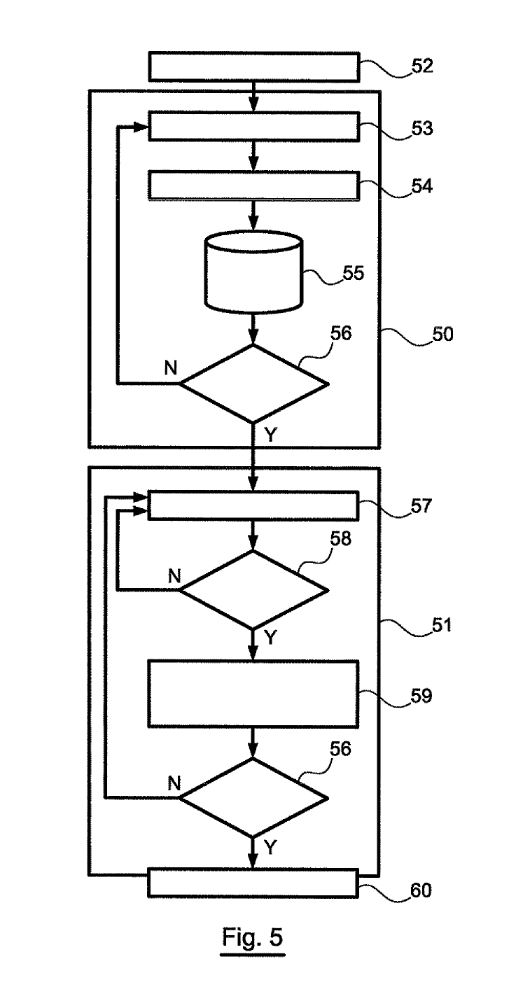

FIG. 4 presents the tree structure (PBTree) associated with such a representation. Each node 40ᵢ of this PBTree stores a 2D½ model of a building at a given level of detail. The simplifications used to generate this multilevel representation of details of a set of buildings are 3 in number:
the elimination of a peak of the ground footprint;
the merger of two adjacent buildings;
the merger of two non-adjacent buildings.

Thus, in FIG. 4, the set of nodes referenced 41 groups together all the nodes that can be merged, and the set of nodes referenced 42 represents the list of active nodes (i.e. the nodes whose associated contents are visualizedon the client terminal and are liable to be refined).

In addition to this tree, the town model is described by means of a vector that defines the footprints of the buildings associated with each of the nodes. Each node must contain a 2D ½ representation enabling the 3D reconstruction of the associated building, and comprises the following elements:
a tree node structure;
a building ground footprint (a polygon indexed to the above vector);
a height;
an altitude;
a roof model;
as the case may be, one or more parameters enabling a more complex 3D modeling of the building.

This representation enables progressive or gradual viewpoint-dependent transmission to the client.

The description of the PBTree, as well as the building process, and its uses in the case of overflight navigation mode has been extensively described in the article “PBTree—A new progressive and hierarchical representation for network-based navigation in urban environments”, VMV 2003, Munich, Germany mentioned here above, and is not the object of the present patent application. However, reference could be made there for further information on the PBTree concept.

The implementation described here below pertains more specifically to the selection of the nodes to be transmitted as a function of the user's position.

FIG. 5 is a block diagram of the method for generating the description file of the tree structure, comprising six successive steps, organized in two main phases. This generation is carried out by the server, either on the storage of the visualization data of an object or upon reception of a first request by a user wishing to access this object.

The first phase 50 consists of a computation of the selection zones associated with each of the nodes. It starts with a loading 52 of the entire tree representing the object (scene or image, in this case a town), which the client terminal wishes to visualize. In an iterative loop, the server then goes 53 through each of the nodes of the loaded tree, in an arbitrary scanning order. For each of the nodes scanned, the server determines 54 the node selection zone, i.e. the geographic zone in which the user must be located to need the loading of the content of the node. In one particular example of an embodiment, it is proposed to use, for defining the selection zone, a geometrical error which is computed as a function of the original model. More specifically, the selection zone is a sphere whose radius is chosen as a function of a geometrical error relative to the original model, in using a generic cost function with multiple parameters.

The server saves 55 the centre of each of the selection zones that it has just computed, and then verifies 56 that all the nodes of the tree have truly been processed. If not, it loops back to the step referenced 53 for scanning the tree; if yes, it goes to the second phase of the method.

The second phase 51 for generating the simplified representation of the hierarchical tree consists of a verification of the property of inclusion of the zone of the son nodes in that of the father nodes. Indeed, in this particular example of an embodiment, it is dictated that this inclusion constraint should be verified for all the nodes of the tree. This second phase 51 is optional.

Again, the server scans 58 through each of the nodes of the tree, but the scanning order is henceforth dictated: first, the nodes at the bottom of the tree, i.e. the leaf nodes, are scanned and the operation ends with the root. For each of the nodes scanned, a check is made to see whether the node has one or more sons. If not, the operation returns to the previous step 57 for scanning the nodes of the tree. If the response is positive, the operation passes to the next step 59 for verifying the inclusion of the selection zones for the set of son nodes in the father node selection zone. The ancestry test 58 indicates that there can be no modification of the selection zones associated with leaf nodes of the tree.

The step 59 of verification of the property of inclusion of the selection zones for the son nodes and father nodes applies the following computation: Let Oₚ be the centre of the selection zone for the father node p and Oₙ the centre of the selection zone for the son node n. Let Rₚ be the radius of the selection zone for the father node p and Rₙ the radius of the selection zone for the son node n. We have dₙ the distance between Oₚ and Oₙ.

The following has to be verified:

∀ₙ,dₙ+Rₙ<Rₚ

If this inequality is not verified for at least one of the son nodes, the selection zone of the father node is broadened so that the inclusion property is complied with.

A test 56 is then conducted to check that all the nodes of the tree have been properly processed. If the result is negative, the server loops back to the step 57 of scanning the tree and, if the result is positive, the generation of the simplified representation of the hierarchical tree is terminated 60.

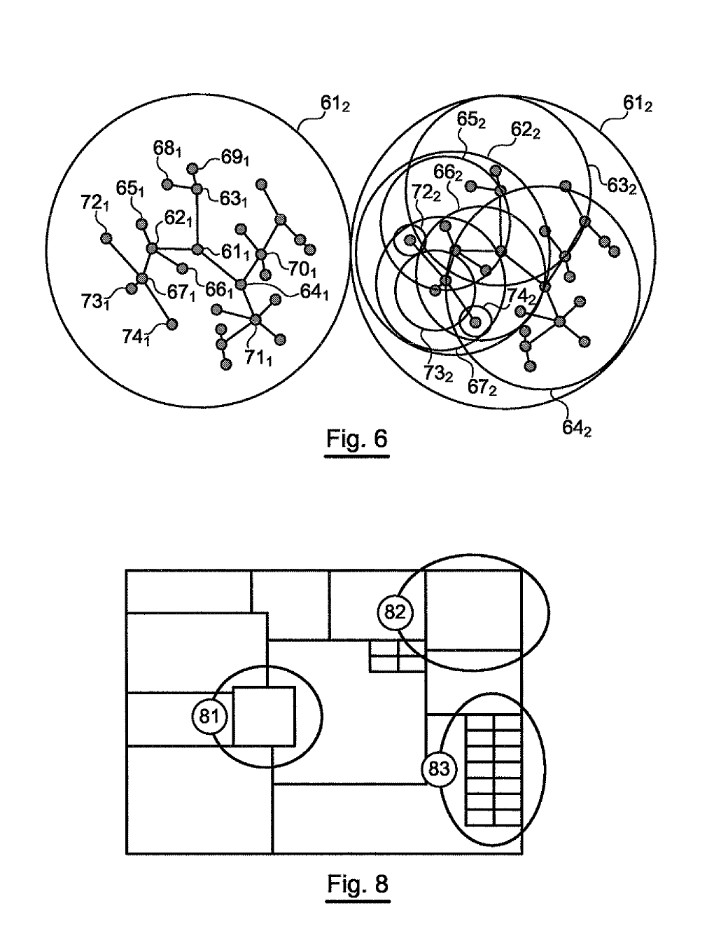

FIG. 6 illustrates the geometrical representation of the description file of the tree structure generated according to the diagram of FIG. 5. The visualizable elements associated with each of the nodes have a position in the description space of the town. The left-hand part of FIG. 6 illustrates the different nodes 61₁ to 74₁ of the tree structure enabling the town considered to be described, as well as the selection zones 61₂ associated with the root node 61₁ of this tree structure. The right-hand part of FIG. 6 illustrates the property of inclusion of the selection zones for the nodes 61₁ to 74₁. It will be noted that a node and the associated selection zone carry the same numerical reference, barring the index, the index associated with the node being 1 and the index associated with the selection zone being 2.

As can be seen in FIG. 6, the selection zones 72₂, 73₂ and 74₂ associated with the leaf nodes 72₁, 73₁, and 74₁, are included in the selection zone 67₂ associated with the node referenced 67₁. Similarly, the selection zones 65₂, 66₂ and 67₂ associated with the son nodes 65₁, 66₁, and 67₁, are included in the selection zone 62₂ associated with the node referenced 62₁. Finally the selection zones 62₂, 63₂ and 64₂ associated with the nodes 62₁, 63₁ and 64₁ are included in the selection zone 61₂ associated with the root note 61₁.

In this example of an embodiment, in the case of a 2D representation, the selection zones are circles. In the case of a 3D model, the selection zones are spheres. It is important to note that the centers of these spheres are not necessarily situated in a same plane (except if there is no relief feature in the town). FIG. 6 must therefore be considered to be a top view in the case considered of a representation of a town.

It is of course possible to envisage the use of other representations for the selection zones (squares, polygons etc) if the tree structure contains different visualization data.

At the end of the processing of FIG. 5, a file is thus obtained containing the following for each of the nodes of the hierarchical tree:
the index of the node in the tree;
the position of the centre of gravity of the node (in the form of Cartesian coordinates (x, y, z) in a reference system associated with the representation of the town);
the selection zone for this node (expressed in the form of a radius r, the selection zone being a sphere centered on the centre of gravity of the node);
the index of the father node.

In one variant, instead of indicating the index of the father node, it is also possible, for each node, to indicate the number of son nodes that it possesses.

It is this file that is transmitted to the client terminal upon reception by the server of an initialization request (referenced 30₁ in FIG. 3). In order to optimize the loading time by the client terminal, it is possible to choose a particular organization of the different nodes of this file.

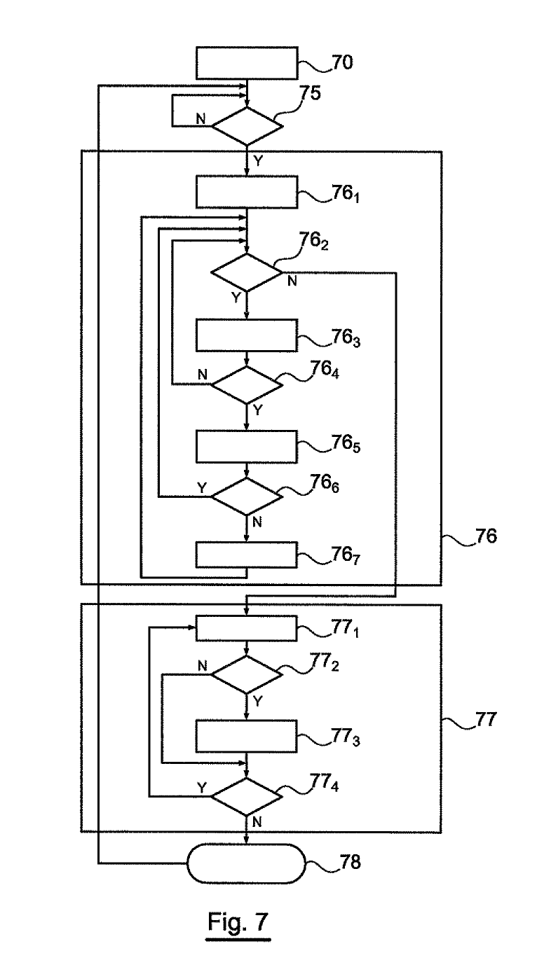

FIG. 7 illustrates the mechanism of selection of the nodes of interest, implemented by the client terminal to visualize the town upon reception of this file.

In this example of an embodiment, it is the client who selects the nodes to be visualized. It is the client who transmits the requests to the server asking it to send him the data that he needs to visualize the tree structure. Indeed, the simplified tree representation (or description file of the tree structure) does not contain the geometrical information by which it is possible to reconstruct the town and the client must therefore ask the server for this information once he has selected a node.

In one alternative embodiment, a case could be envisaged where the selection of the nodes and the sending of the requests are shifted to an intermediate apparatus of the network, provided for example with greater processing capacities than the client terminal.

The selection of the nodes of interest by the client terminal (or by an intermediate apparatus of the network) comprises two main phases, namely a phase 76 for generation of a list of nodes of potential interest (LNP) from a list of nodes to be tested (LNT), and a second phase 77 for refining the LNP list to select the nodes to be loaded or to be transmitted.

The client terminal first of all loads 70 the simplified representation of the tree, then tests 75 to see whether the user's position in this scene has changed since the last selection of nodes of interest. If it is a first selection of nodes of interest, the response to this question is positive and enables the client terminal to enter the first processing phase 76. The list of nodes to be tested LNT is initialized 76₁ with the root node of the tree. Then a test is made 76₂ to see if the LNT list is not empty. If the answer is negative, the operation passes to the second processing phase 77. If the answer is positive, the first node of the LNT is removed 76₃ and taken as the current node.

The step referenced 76₄ consists in verifying to see whether the current position of the user is included in the selection zone of the current node. Let 0 be the observer's position, On the centre of the zone of selection of the current node and Rn the radius of this zone. If |On-O|<Rn, there is inclusion.

The operation then passes to the next step 76₅ in which the current node is added to the list LNP of the potential nodes, i.e. nodes that are potentially nodes of interest. A test is then made 76₆ to find out if this node is a leaf. If the answer is negative, the son nodes of this node are added to the end of the LNT list.

If the user's position is not in the selection zone of the current node (result of the step referenced 76₄), or if the current node is a leaf (result of the test referenced 76₆) then, the operation loops back to the step referenced 76₂ in which a test is performed to see if the LNT list is not empty.

The second processing phase 77 may be considered to be a phase of correction of the LNP list to prevent transmission redundancies between the server and the client. Each of the nodes of the LNP list is scanned 77₁ and, for each node, a check is made 77₂ to find out if this node is present in the client's cache (the use of the cache is necessary to prevent transmission of the same information several times). If the node is already in the cache, then the node is withdrawn 77₃ from the LNP. Then, if there is a negative response to the test referenced 77₂, the step 77₄ is performed to determine whether there remain nodes to be verified in the LNP. If this is so, the operation loops back to the first step 77₁ of the second phase 77.

If not, with the corrected LNP list, the client terminal has available all the nodes of interest whose contents are necessary to it in order to visualize the town. It can then send the server a request for obtaining geometrical data associated with each of these nodes.

The step referenced 78 is the step for transmission of the geometrical data of the node if necessary (if this data is not in the cache). Then, the operation returns to the step referenced 75 for testing new positions until all the geometrical data of the nodes of interest has been loaded.

To optimize the processing of FIG. 7, it is possible to avoid testing the son nodes if the father node is not selected as the node of interest. With this optimization, it is not necessary to scan the tree in its totality to determine the nodes whose content is visible to the user (it being known that the selection zones for the son nodes are included in that of their father).

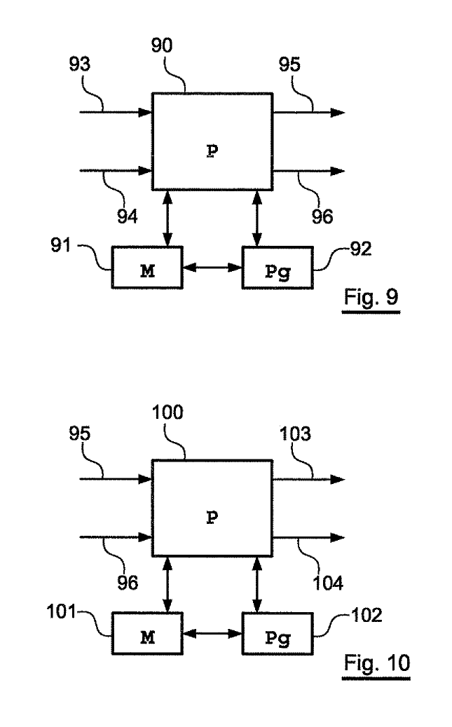

FIGS. 9 and 10 show two block diagrams of the server and the client terminal. Thus, the server has a memory M 91 and a processing unit 90 equipped with a processor P which is driven by the computer program Pg 92. The processing unit 90 receives visualization data 93 for the visualization of a 3D image or scene, organized in the form of a hierarchical tree from which the processor P, following the instructions of the program Pg 92, generates a simplified representation 95 of the tree that does not contain the geometrical information of the nodes. The processing unit 90 also has an input designed to receive the requests 94 of a client terminal from which the processor P activates the transmission of the simplified representation 95, or geometrical data 96 enabling the terminal to rebuild the contents to be visualized as a function of its viewpoint.

The client terminal for its part comprises a memory M 101, and a processing unit 100 equipped with a processor P which is driven by the computer program Pg 102. The processing unit 100 receives at input the simplified representation 95 of the hierarchical tree generated by the server, from which the processor P, following the instructions of the program Pg 102, selects one or more nodes of interest as a function of the user's viewpoint and sends out a corresponding request 103 to the server. The processing unit 100 also has an input designed to receive geometrical data 96 given by the server, from which the processor P rebuilds the contents to be viewed 104 as a function of its viewpoint.

In short, the technique enables faster loading of tree-structured data. It is not necessary to scan all the visible nodes to know whether it is necessary to develop them or merge them. Nor is it necessary to transmit the nodes recursively.

Furthermore, in the case of a very fast movement of the user in the scene to be visualized, it is possible to cancel the transmission of the nodes that have become obsolete, given the new position.

In the particular case where the content to be viewed by the client terminal is a 2D image, and if the selection zones associated with the image are regular, it is possible to generate a description file of the tree structure of the image containing several types of compression formats.

Conversely, if only one compression format is used, it is possible to adapt the selection zones according to the content of the image.

FIG. 8 shows this example of use: the mapping of the image being known, the user can ask for the information that he needs according to his position relative to the image. The different zones 81, 82, 83 of FIG. 8 could correspond to different compression formats (JPEG, JPEG 2000 . . . ). Since each of these formats has different properties, it is indeed worthwhile to exploit their specific characteristics as a function of the content of the image in the zones considered. It is also possible to envisage the exploitation of this mapping to create a compression format that takes account of the content of the image that it compresses. For example, for JPEG 2000, it is not possible to have tiles of different sizes according to the zones.

Although the present disclosure have been described with reference to one or more examples, workers skilled in the art will recognize that changes may be made in form and detail without departing from the spirit and scope of the disclosure and/or the appended claims.

1-11. (canceled)

12. Client terminal for the visualization of a content from visualization data arranged in nodes of a hierarchical tree comprising at least one parent node and at least one son node, a visualizable element being associated with each of said nodes wherein the client terminal comprises:
means of reception of a simplified representation of said tree, transmitted by a server, and comprising, for at least certain of said nodes, a piece of information for locating said visualizable element in said content to be visualized; and not comprising geometrical data enabling a reconstruction of said visualizable element;
mean of selection, from said simplified representation, of at least one node of interest in said content to be visualized; and
means of reception of geometrical data enabling a reconstruction of said visualizable element for said selected at least one node of interest.

13. Client terminal according to claim 12, wherein said simplified representation comprises for each of said nodes of the tree:
an identifier of said node;
a piece of information enabling said node to be linked to at least one of said parent node of said node or said son nodes of said node;
a position of a centre of said visualizable element associated with said node in said content to be visualized; and
a zone of selection of said visualizable element associated with said node.

14. Client terminal according to claim 13, wherein said selection means are capable of selecting a node of said tree as a node of interest if a current position of said client is included in said selection zone.

15. Client terminal according to claim 14, and further comprising means of transmission of a request for obtaining said visualization data of said nodes of interest to said server.

16. Client terminal according to claim 15, and further comprising means of verification of presence of said visualization data of said nodes of interest in a cache of said terminal and wherein said transmission means do not send said request to said server for said visualization data already present in said cache.

17. Client terminal according to claim 15, and further comprising means of cancellation, applied in the event of a change in said current position of said client, capable of asking said server for cancellation of said request for obtaining said visualization data from at least one node which is no longer a node of interest, if said visualization data have not yet been transmitted by said server.

18. Client terminal according to claim 1, wherein said selection means authorize scanning of a node of said simplified representation to determine whether a criterion of distance from said client terminal to said visualizable element associated with said node of interest is verified for said scanned node only if said parent node of said scanned node is a node of interest.

19. Client terminal according to claim 12, and further comprising means of transmission of a request for obtaining said visualization data of said nodes of interest to said server.

20. Server for the visualization of a content designed for at least one client terminal, from visualization data being arranged in nodes of a hierarchical tree comprising at least one parent node and at least one son node, a visualizable element being associated with each of said nodes, wherein the server comprises:
means of generation and transmission to said client of a simplified representation of said tree comprising, for at least certain of said nodes, a piece of information for locating said visualizable element in said content to be visualized and not comprising any geometrical data enabling a reconstruction of said visualizable element, so that said client performs a selection, from said simplified representation, of at least one node of interest in said content to be visualized; and
means of transmission of geometrical data enabling a reconstruction of said visualizable element for said selected node or nodes of interest.

21. Method of transmission of data for the visualization of content between a server and at least one client terminal, said data being arranged in nodes of a hierarchical tree comprising at least one parent node and at least one son node, a visualizable element being associated with each of said nodes, wherein the method comprises the following steps:
transmission by said server to said client of a simplified representation of the tree comprising, for at least certain of said nodes, a piece of information for locating said visualizable element in said content to be visualized; and not comprising any geometrical data enabling a reconstruction of said visualizable element;
selection, by said client terminal, from said simplified representation, of at least one node of interest in said content to be visualized; and
transmission of geometrical data enabling a reconstruction of said visualizable element for said selected node or nodes of interest.

22. Computer program product recorded on a carrier usable in or by a processor, the product comprising program code instructions for the execution of the following steps for the transmission of content visualization data between a server and at least one client terminal when said program is executed by the processor, said data being arranged in nodes of a hierarchical tree comprising at least one parent node and at least one son node, a visualizable element being associated with each of said nodes:
transmission by said server to said client of a simplified representation of the tree comprising, for at least certain of said nodes, a piece of information for locating said visualizable element in said content to be visualized; and not comprising any geometrical data enabling a reconstruction of said visualizable element;
selection, by said client terminal, from said simplified representation, of at least one node of interest in said content to be visualized; and
transmission of geometrical data enabling a reconstruction of said visualizable element for said selected node or nodes of interest.

23. Signal representing data for the visualization of a content intended for at least one client terminal, said data being arranged in nodes of a hierarchical tree comprising at least one parent node and at least one son node, a visualizable element being associated with each of said nodes, wherein said signal comprises:
a first portion, which bears a simplified representation of said tree comprising, for at least certain of said nodes, a piece of information for locating said visualizable element in said content to be visualized and not comprising geometrical data enabling a reconstruction of said visualizable element;
wherein said portion of said signal bears geometrical data enabling a reconstruction of said visualizable element for at least one node of interest in said content to be visualized.
